(19) United States
(12) Patent Application Publication
(10) Pub. No.: US 2015/0317629 A1
(43) Pub. Date: Nov. 5, 2015

(54) SYSTEMS AND METHODS FOR AUTHORIZING A PURCHASE TRANSACTION USING NET WORTH ESTIMATE

(71) Applicant: MasterCard International Incorporated, Purchase, NY (US)

(72) Inventor: Bejoy Mathew, Dardenne Prairie, MO (US)

(73) Assignee: MasterCard International Incorporated, Purchase, NY (US)

(21) Appl. No.: 14/266,046

(22) Filed: Apr. 30, 2014

(51) Int. Cl. G06Q 20/40; G06Q 20/34

(52) U.S. Cl. CPC G06Q 20/40; G06Q 20/34

(57) ABSTRACT

Systems and methods for permitting a consumer to consummate a purchase transaction when the purchase transaction amount exceeds an available credit limit and that consumer has assets to cover the overage amount. Thus, in some embodiments a net worth confirmation platform receives transaction information, transmits the transaction information to an Issuer financial institution (FI), receives an indication from the Issuer FI that the that the transaction is unauthorized, and determines that at least one business rule applies to the transaction and an overage amount. The net worth confirmation platform also determines a net worth estimate of the consumer based on at least one asset of the consumer, and transmits a transaction authorization message to the merchant when the business rule(s) is or are satisfied.

### BACKGROUND

A typical customer pondering whether or not to make a purchase from a merchant will typically consider his or her current cash “on hand” (for example, the cash available in various saving and/or checking accounts) and an amount of credit that is readily available (for example, via an existing credit card or home equity line of credit). If the cost of the transaction is greater than, or even constitutes a substantially large portion of, his or her overall cash and available credit amounts, the customer may be unlikely to complete the transaction. For example, a customer who is considering purchasing a fine art painting from an art gallery may have $50,000 in his or her bank account and a $15,000 limit on his or her credit card. But if the price of the painting is $75,000, the customer will be unlikely to complete the purchase.

High net worth individuals or affluent consumers (those with assets of one million dollars or more) typically hold one or more premium credit cards with high credit limits. However, an affluent consumer having such a premium credit card with, for example, a fifty thousand dollar ($50,000) credit limit wishing to purchase a $75,000 painting with that credit card will find that the transaction will be declined. Moreover, the merchant (such as the art gallery owner) may be hesitant to arrange for additional credit to be extended to the affluent customer because the merchant cannot easily and/or readily and/or quickly confirm whether or not that customer does indeed have assets that would cover such an expensive transaction. Moreover, even if the art gallery owner does decide to arrange for additional credit, the interest rate required to cover the risks involved with such a high transaction amount may be substantial, and the affluent customer may decide that the interest rate is too high. In such cases, since the affluent consumer cannot perform the purchase transaction for the painting, he or she may decide to forego the purchase, resulting in the gallery owner losing the sale of an expensive item and perhaps losing the affluent consumer as a customer.

The present inventor recognized that a need exists for systems and methods to quickly and easily provide an estimate of the net worth of an affluent consumer so that a purchase transaction can be consummated with his or her payment card account even when the transaction amount exceeds the available credit or credit limit of that payment card account.

### BRIEF DESCRIPTION OF THE DRAWINGS

FIG. 1 is a block diagram of a system for estimating the net worth of a consumer to enable consummation of a purchase transaction according to some embodiments of the disclosure;

FIG. 2 is a block diagram of a system for estimating the net worth of a consumer to enable consummation of a purchase transaction according to some embodiments;

FIG. 3 illustrates a consumer net worth confirmation process according to an embodiment that may be performed utilizing the systems of FIGS. 1 and 2;

FIGS. 4A and 4B illustrate net worth confirmation registration displays for receiving input from a consumer according to some embodiments of the disclosure;

FIG. 5 illustrates a registration method according to some embodiments of the disclosure;

FIG. 6 is a block diagram overview of an alternate net worth confirmation platform system according to some embodiments of the disclosure;

FIG. 7 illustrates a net worth confirmation platform that may be associated with the systems of FIGS. 1, 2, and 6 according to some embodiments of the disclosure;

FIG. 8 is a table illustrating the types of data that may be stored in a registration database according to some embodiments of the disclosure; and

FIG. 9 is a table illustrating an example of a purchase transaction database according to some embodiments of the disclosure.

### DETAILED DESCRIPTION

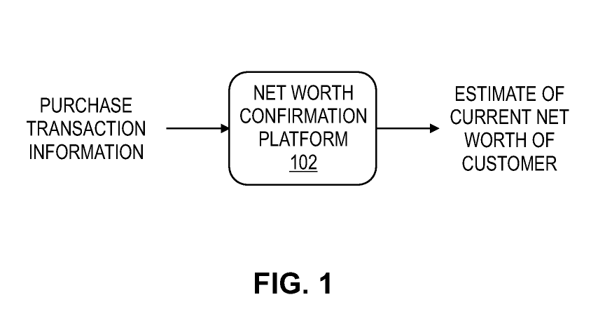

Presented herein are systems and methods for quickly and easily permitting a consumer to consummate a purchase transaction when the purchase transaction amount exceeds an available credit limit and that consumer has assets to cover the overage amount (i.e., the overage amount being the amount of the purchase price that exceeds the available credit limit). In particular, FIG. 1 is a block diagram of a system 100 for estimating the net worth of a consumer to enable consummation of a purchase transaction according to some embodiments of the disclosure. In particular, the system 100 includes a net worth confirmation platform 102 that receives purchase transaction information. The purchase transaction may be associated with, for example, a customer who is considering making a purchase from a merchant. The purchase transaction information may be received, according to some embodiments, directly from a merchant device (for example, a point of sale (POS) terminal), or via a webpage associated with a merchant website, or from a merchant mobile device via a wireless communications network, and the like.

The net worth confirmation platform 102 may operate in any of the ways described herein and may output an indication associated with an estimate of the current net worth of a consumer based on one or more assets owned by the consumer. Such information may be output to, for example, one or more issuer processors associated with one or more Issuer financial institutions (FIs) which issued a payment card account to the customer, and/or to a merchant device, and/or via a payment card network to an Issuer FI and/or a merchant device.

The net worth confirmation platform 102 might be associated with, for example, a Personal Computer (PC), laptop computer, a computer network or computer system that includes a plurality of computers, an enterprise server, a server farm, and/or a database or similar storage devices. In addition, the net worth confirmation platform 102 may, according to some embodiments, be associated with a credit card company. According to some embodiments, an “automated” net worth confirmation platform 102 facilitates determining net worth data concerning consumer assets. For example, the net worth confirmation platform 102 may automatically respond to purchase transaction requests received from a number of different merchants (including online merchants) to determine net worth estimates of a number of different customers. As used herein, the term “automated” may refer to, for example, actions that can be performed with little (or no) human intervention.

As used herein, devices, including those associated with the net worth confirmation platform 102 and any other device described herein, may exchange information via any type of communication network, which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks, and communications may be in a secured manner (for example, data and/or messages communicated between devices may be encrypted and then decrypted for security purposes).

Although a single asset confirmation platform 102 is shown in FIG. 1, any number of such devices may be included, and each may include one or more computers. Moreover, various devices described herein might be combined according to some embodiments. For example, in some implementations, the asset confirmation platform 102 and a business rules and logic database might be co-located and/or may comprise a single apparatus.

In accordance with some embodiments, the systems and methods described herein provide a framework to expand a customer's payment ecosystem beyond his or her current cash on hand and available credit. For example, a payment card may be presented by a cardholder (e.g., the account owner) to a merchant to consummate a purchase transaction. By way of example, and without limiting the generality of the foregoing, a payment card can be a credit card, debit card, charge card, stored-value card, prepaid card or nearly any other type of financial transaction card. Further, as used herein, the term “Issuer” or “attribute provider” can include, for example, an Issuer financial institution (for example, a bank) that issues payment cards to consumers, a merchant issuing a merchant specific card, a stand-in processor configured to act on-behalf of the card-Issuer, or any other suitable institution configured to issue a payment card and/or payment card account. As used herein, the term “transaction” or “purchase transaction” can be associated with, for example, a merchant, a merchant terminal, an automated teller machine (ATM), a merchant website, or any other suitable institution or device configured to initiate a financial transaction per the request of the account owner.

The information exchanged with the net worth confirmation platform 102 may be associated with, for example, a “payment card processing system” or “credit card processing networks”, such as the MasterCard® network operated by the assignee hereof, that allows account owners to use payment cards issued by a variety of Issuers to shop at a variety of merchants. With this type of payment card, a card Issuer or attribute provider, such as a bank, extends credit to an account owner to purchase products or services. When an account owner makes a purchase from an approved merchant, the card number and amount of the purchase, along with other relevant information, are transmitted via the processing network to a processing center, which verifies that the card has not been reported lost or stolen and that the card's credit limit has not been exceeded. In some cases, the account owner's signature is also verified, a personal identification number is required or other user authentication mechanisms are imposed. The account owner is required to repay the Issuer bank for the purchases, generally on a monthly basis.

Examples of “premium” credit cards, which are typically only offered to and/or obtained by affluent consumers due to their stringent consumer credit score requirements and/or net worth requirements include, but are not limited to, the MasterCard Black™ credit card, the Platinum Card® by American Express, and the Chase Sapphire Preferred® card. Such premium payment card products may include a high credit limit (e.g., $40,000 or more) and come with various benefits, such as complimentary concierge services, access to exclusive airport lounges, free rental car upgrades, and the like. In exchange for the benefits, such premium credit cards may require an annual fee of several hundred dollars or more, but may also provide mileage points and/or rebates depending on the dollar amounts spent for goods or services from predetermined types of merchants and the like.

In accordance with some embodiments, the purchase transaction data received by the net worth confirmation platform 102 may include, for example, a time and date for a payment card transaction, a sales amount including the type of goods and/or services sold, a total number of goods and/or services sold in the transaction, a total sales amount for the transaction (e.g., gross dollar amount or purchase transaction amount). In addition, depending on the merchant and/or business, the data associated with the transaction may include a point-of-sale or point-of-purchase (e.g., location of each payment card transaction). The point-of-sale or point-of-purchase provides, for merchants and/or businesses having one or more locations, data concerning the location of the merchant and/or business that generated the sale so it can be identified.

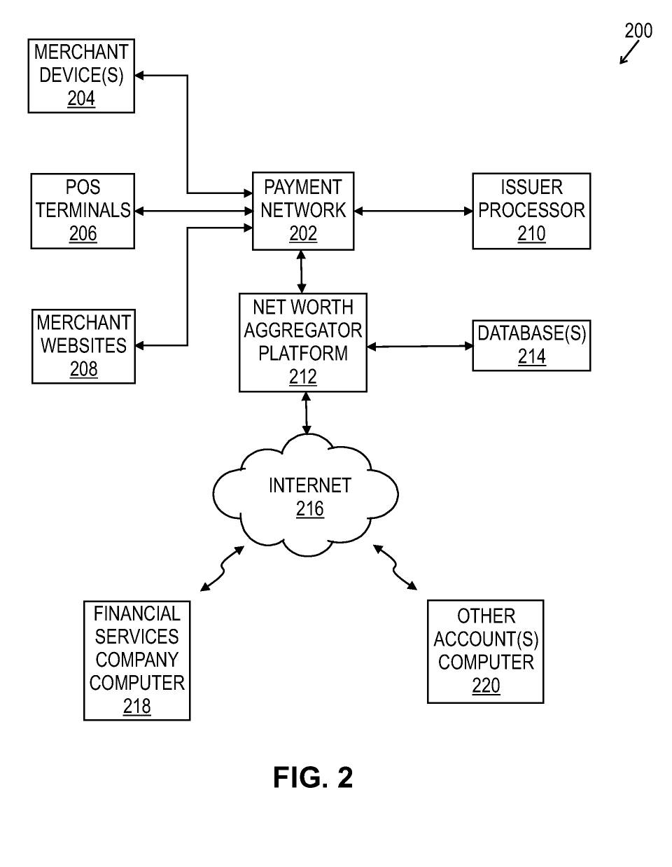

FIG. 2 is a block diagram of a system 200 for estimating the net worth of a consumer to enable consummation of a purchase transaction according to some embodiments. It should be understood that the various blocks shown in FIG. 2 may represent any number of processors, computers and/or computer systems configured for communicating information via any type of communication network, and communications may be in a secured or unsecured manner. According to the embodiment of FIG. 2, a merchant point of sale (POS) terminal 206, and/or a merchant website 208, and/or a merchant device 204 (for example, a merchant mobile device such as a mobile telephone, tablet computer or laptop computer) may transmit transaction information and other information to a payment network 202 (or credit card network), which may be forwarded to a net worth aggregator platform 212. For example, in some embodiments, the payment network 202 my communicate with the issuer processor 210, which represents a plurality of Issuer financial institutions (FIs), and may be operated by a third party on behalf of one or more Issuer FIs. The payment network 202 may next be informed by the issuer processor 210 that the customer has exceeded his or her credit limit for the purchase transaction, and also be supplied with instructions to communicate with the net worth aggregator platform 212. The cardholder or customer may have enabled a net worth confirmation feature associated with his or her credit card at his or her Issuer financial institution (FI) to cover just such a situation. The net worth confirmation feature is an opt-in feature, meaning that a customer must provide consent for the feature to be activated. In some embodiments, such a net worth confirmation feature might be offered as an added value aspect of a premium credit card account. When the net worth aggregator computer 212 receives the transaction information from the payment processor 202, it may exchange data with database(s) 214, and/or with a financial services company computer 218 via the internet 216 (or other network), and/or with an “other” accounts computer 220 via the internet 216 (or other network). The net worth aggregator platform 212 may then operate to determine a current estimate of the customer's net worth. In some embodiments, the estimated net worth of the consumer or cardholder is then transmitted to the payment network 202, which may then authorize the purchase transaction on behalf of the Issuer FI if a business rule is satisfied (which will be explained herein).

In accordance with some embodiments, the other accounts computer 220 represents one or more computers associated with entities holding other types of financial accounts and/or financial information of the consumer. Such other accounts may be associated with, but are not limited to, stock trading accounts, money markets accounts, real estate investment trust accounts, retirement fund accounts, college saving plan funds, and the like, which may be sponsored by different types of financial services companies. In addition, such accounts could have a value associated with real estate, such as a residence, a summer home, and/or an apartment building, or other types of property such as one or more automobiles or other types of vehicles, a boat, and/or a business.

In some embodiments, information regarding any real estate loans (such as a mortgage), personal loans, or other types of loans or amounts owed by the consumer may also be obtained by the net worth aggregator computer 212 from, for example, one or more credit agencies (not shown). In this manner, the net worth aggregator computer may aggregate many different types of financial information of a customer to determine, by adding together the value of assets and subtracting the value of any liabilities, an estimated net worth to associate with the customer.

In some embodiments, the net worth confirmation platform 102 of FIG. 1 may include components such as the payment network 202, the net worth aggregator platform 212, the database(s) 214, and any network connections or other communications access to the financial services company computers 218 and/or other accounts computers 220. In other embodiments, the net worth confirmation platform 102 may include the payment issuer processor(s) 210, the net worth aggregator platform 212 and the database(s) 214, and any interconnections (not shown) between the net worth aggregator computer 212 and one or more issuer processor(s) 210 for exchanging financial information regarding customer assets and/or liabilities.

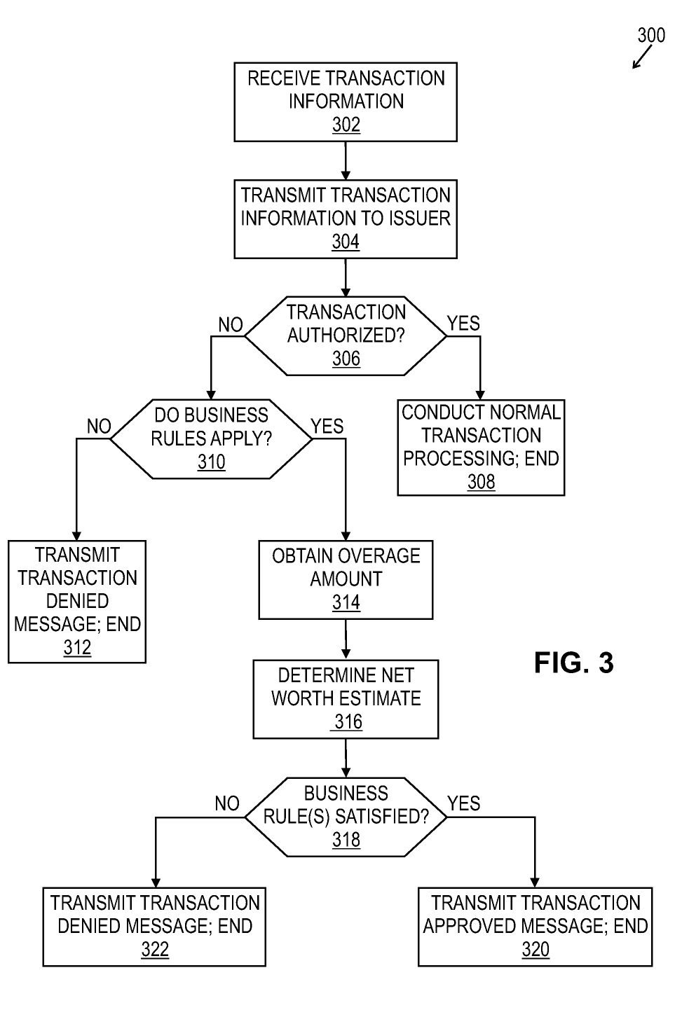

FIG. 3 illustrates a consumer net worth confirmation process 300 according to an embodiment that may be performed utilizing the system 100 and/or the components of the system 200 described above with respect to FIGS. 1 and 2. It should be understood that the flow charts described herein do not imply a fixed order to the steps, and embodiments may be practiced in any order that is practicable. Note that any of the methods described herein may be performed by hardware, software, or any combination thereof. For example, a non-transitory computer-readable storage medium may store instructions thereon that, when executed by a processor or machine, result in the performance of one or more of the processes according to any of the embodiments described herein.

Referring to FIG. 3, the net worth confirmation platform receives 302 transaction information from a merchant, for example, via a merchant device or a merchant website. The transaction information may include, for example, an account identifier, a merchant identifier, a date, a time of day, a payment amount (or purchase transaction amount), a payment description, or any other type of purchase transaction information. The transaction information may also identify the type of payment account being used by the customer, for example, a credit card account, a debit card account, a bank account, a pre-paid card account, a stored-value card account, or any other type of payment account. The purchase transaction information might be received by, for example, a credit card network (or payment network operated by a payment card processing company such as MasterCard International Incorporated) that is part of the net worth confirmation platform directly from a remote merchant device. In some embodiments, the transaction information is associated with an online purchase, such as a purchase being made via an electronic shopping cart at a retail website associated with the merchant and/or an electronic wallet account.

Referring again to FIG. 3, the payment network associated with the net worth confirmation platform may next transmit 304 the transaction information to the appropriate Issuer financial institution (FI). For example, the transaction information may be transmitted to an Issuer FI that issued a premium credit card account to the consumer involved in the current transaction. The net worth confirmation platform then receives a response 306 from the Issuer FI, which may be a “transaction authorized” message indicating that the transaction amount does not exceed, or is within, a credit limit and available credit amount of the payment card account that the customer is using for the purchase transaction. If so, then in step 308 normal transaction processing occurs (for example, the transaction is approved, a transaction authorized message sent to the merchant, and settlement occurs) and the process ends.

If a transaction authorized message is not received in step 306 from the Issuer FI, then the net worth confirmation platform determines 310 if one or more business rules apply. The net worth confirmation platform may make such a determination based on information received from the Issuer FI, or from information stored in a business rules database. For example, a business rules database may include data identifying the customer's payment card account as having one or more business rules associated with it for use in processing transactions. Many different types of business rules are contemplated, which may be promulgated by various Issuer FIs that offer premium credit card accounts. For example, an Issuer FI may have a business rule allowing consumers holding a particular type of premium credit card to make purchases of up to $8,000 that will always be authorized regardless of remaining credit limit. Such a business rule is desirable, for example, when that type of premium credit card account is only issued to affluent consumers having liquid assets of at least $750,000, which makes the risk of the consumer defaulting on a particular purchase of $8,000 or less relatively small. Referring again to FIG. 3, if no business rules apply to the customer's payment account, then the payment network transmits 312 a transaction denied message to the merchant, and the process ends.

However, if in step 310 the payment network determines that one or more business rules do apply to the consumer's payment account, then the net worth confirmation platform obtains 314 the overdrawn amount for the transaction. In some implementations, the net worth confirmation platform communicates with the Issuer FI to obtain the overage amount, while in other embodiments the net worth confirmation platform calculates the overage amount based on the transaction amount and information from the Issuer FI and/or other sources. Next, the net worth confirmation platform determines 316 an estimate of the customer's net worth.

In some embodiments of the net worth confirmation platform, the associated payment network transmits the transaction amount and other transaction data to the net worth aggregator 212 for processing (see FIG. 2). For example, if a consumer wishes to purchase a $30,000 car with her Premium MasterCard credit card which has a credit limit of $40,000 but, perhaps due to prior purchases or a spouse having used the card for other purchases (perhaps without her knowledge), that credit card account has an available credit of only $23,000. Following this example, use of that credit card account causes an overage amount of $7,000 (e.g., the difference between the purchase price of the car and the available credit limit) with regard to the purchase price of the car. Thus, with reference to FIG. 2, the payment network 202 communicates with the net worth aggregator computer 212 to determine a net worth estimate of the customer based on at least one asset owned by the customer. The net worth aggregator computer 212 may communicate with one or more database(s) 214 that contain consumer financial information, and/or with the financial services company computer 218 and/or the other accounts computer 220 to make such a net worth estimate. In particular, the net worth aggregator computer 212 functions to obtain at least one cash value amount from one or more financial accounts (or an estimate thereof) of the customer. In some implementations, the customer's assets might include bonds, a retirement account, a business, a vehicle, and/or real estate (e.g., the value of his or her house). Thus, in some embodiments, the net worth confirmation platform may automatically confirm that the customer owns a particular asset (for example, that the customer owns 10,000 shares of a particular stock valued at $110,000).

For example, the net worth aggregator computer may find that the customer holds approximately $110,000 in stock in a brokerage account at a first entity, has about $83,000 in a money market account at a second entity, owns a stock mutual fund at a third entity worth about $42,000, and owns a house valued at approximately $200,000. These dollar amounts are then added together to obtain an estimate of the customer's net worth, and in this example the net worth aggregator computer provides an estimated consumer net worth of $435,000. Referring again to FIG. 3, if the customer's estimated net worth determined in step 316 satisfies 318 at least one business rule, then the payment network 202 may transmit 320, on behalf of the issuer processor 210, a transaction authorization message to the merchant device 204 that authorizes the purchase transaction (even though the credit limit on the payment card account has been exceeded), and the process ends. However, if the customer's estimated net worth does not satisfy 318 at least one business rule, then the payment network 202 transmits 322 (on behalf of the issuer processor 210) a transaction denied message to the merchant device 204 that terminates the purchase transaction, and the process ends.

Many different types of business rules are contemplated that could be used to determine whether or not a customer will be permitted to consummate a purchase transaction even though he or she has exceeded a credit limit or some other limit, or run afoul of some other restriction, associated with his or her payment card account. Note that different business rules or logic might be associated with certain types of merchants, types of customers, types of transaction, types of stock trading accounts, and the like. For example, an Issuer FI of a particular type of premium credit card may institute a business rule that allows consumers holding that premium card to make purchases of up to $10,000 that will always be authorized regardless of remaining credit limit or overage amount. Such a business rule makes sense when that type of premium credit card account is only issued to affluent consumers having liquid assets of at least $1,000,000, so that the risk of a default on a particular purchase of $10,000 or less is relatively low. Another example of a business rule that may be followed is that if the estimated net worth of the customer is at least X number of times (e.g., twelve times) the overage amount of the purchase transaction, then the net worth confirmation platform will authorize the payment transaction on behalf of the Issuer FI. With regard to the example given immediately above, since the overage amount is $7,000, then the consumer must have assets having a cash value of at least $94,000 (12×$7,000) to enable the payment network associated with the net worth confirmation platform to authorize the purchase of the car. Since the estimated net worth of the customer in the example was $435,000, in this example the purchase transaction would be authorized. Other types of business rules and/or business configurations are contemplated, which may evolve based on feedback from Issuer FIs and/or merchants and/or their requirements and/or limitations. Payment network operators and/or Issuer financial institutions may be willing to offer such an overage benefit to their premium account cardholders and/or to their high net worth or affluent customers because such transactions have limited risk of default.

According to some embodiments, the net worth confirmation platform does not arrange for an exchange of funds during the transaction approval period. Instead, a transaction agreement may be in place between the customer, the net worth confirmation platform, and/or the Issuer financial institution prior to the time of any purchase transactions. Such an agreement includes provisions wherein the customer understands that he or she will cover the overage amount by using one or more of his or her assets to complete payment for the purchase transaction. The net worth confirmation platform may generate revenue, for example, via a service fee and/or a per-transaction fee agreement with one or more Issuer FIs. Furthermore, in some embodiments the net worth confirmation platform may be provided as an API (Application Program Interface) or Open API net worth confirmation package. The Open API may be configured to provide an interface to the institution offering the net worth confirmation platform. For example, businesses may use such an Open API net worth confirmation package as a means to conduct credit worthiness checks of cardholders by analyzing the estimated net worth of cardholders. A fee for usage, such as a licensing fee, may be charged by the owner and/or operator of the net worth confirmation platform to businesses that utilize such an API net worth confirmation package.

Accordingly, the processes and systems disclosed herein expand a customer's purchasing power beyond his or her available cash and credit amounts. Thus, embodiments may provide customers with more funds and/or a bigger amount of credit—such as when they are interested in purchasing relatively expensive items. For example, a customer who has a $25,000 credit limit on his or her credit card might be interested in purchasing a $50,000 automobile. Because the car dealer can verify that the customer owns $100,000 work of stock in his or her trading account, the transaction may be enabled and the relatively high interest rates associated with a typical automobile loan may be avoided.

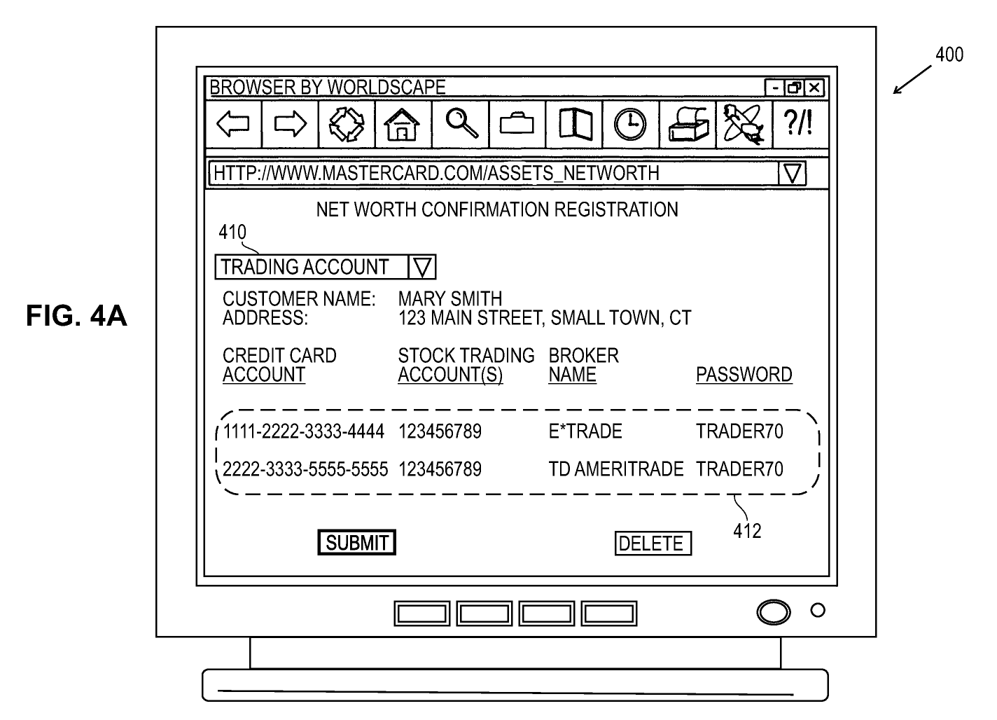

According to the embodiments, a customer may enroll or register to use a net worth confirmation service, for example, with his or her payment account Issuer financial institution. Thus, FIG. 4A illustrates a net worth confirmation registration display 400 that may be provided to a consumer or cardholder according to some embodiments. The consumer may opt-in to the net worth confirmation service through a website operated by his or her Issuer financial institution, by providing various types of financial data input. As shown, the display 400 includes a financial account type selection drop-down menu 410 use by the consumer, Mary Smith, to select various types of accounts to link to her payment card accounts. As shown, the customer has chosen a stock trading account to be linked to two of her credit card accounts, but many other types of accounts, such as retirement investment accounts, mutual fund accounts, money market accounts, and the like, may also be included. The customer can use a data entry area 412 to enter stock trading account identifiers (such as the account numbers), the name of the stock broker company, any user names, passwords, and the like which are required to login to her accounts to identify her assets and/or the value thereof.

FIG. 4B illustrates another example of a net worth confirmation registration display 450 that might be provided in accordance with some embodiments. In particular, the display 450 includes an interactive data input area 452 that a customer can use to add or delete various types of accounts associated with assets that have a financial value. Such financial accounts will fluctuate over time, and thus will increase or decrease his or her overall network of assets that will be utilized in the event that a particular purchase transaction exceeds the credit limit or available credit balance of one or more of the customer's credit card accounts. In addition, the customer may be provided with other types of asset confirmation input displays, such as one for listing real property and/or estimated values of same (such as estimated amounts for real estate, such as for primary residence and any vacation homes; estimated values for automobile(s) or other vehicles owned by the cardholder; and/or estimated values for other property such as jewelry).

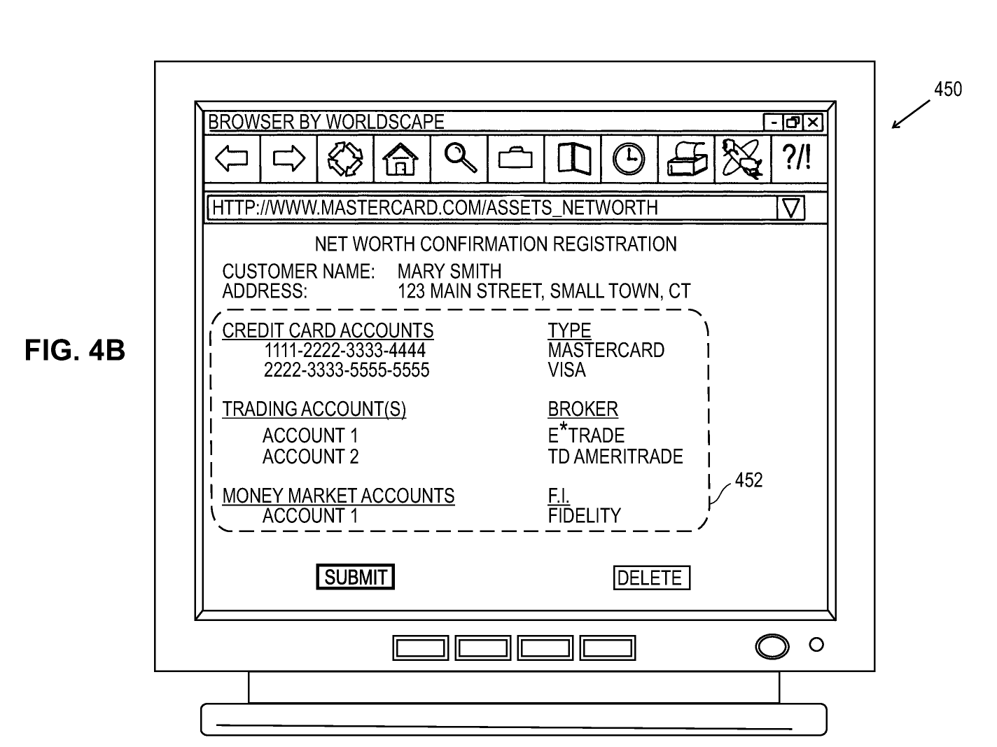

FIG. 5 illustrates a registration method 500 that might be performed in accordance with some embodiments. In step 502, a net worth confirmation platform may receive registration information associated with a customer or cardholder, including a trading account identifier. This information is then stored 504 by the asset confirmation platform in a database for later use when the customer enters into a purchase transaction. The information stored in the database may be associated with, for example, the customer's credit card account number or electronic wallet or digital wallet. The information then can be accessed when a determination is made that a particular purchase transaction amount has exceeded the available credit (or the credit limit) of that credit card account or for that electronic or digital wallet. In some embodiments, only the asset information provided by the cardholder or customer is accessed and/or reviewed to determine whether or not to authorize a purchase transaction that has exceeded the available credit limit of the payment account.

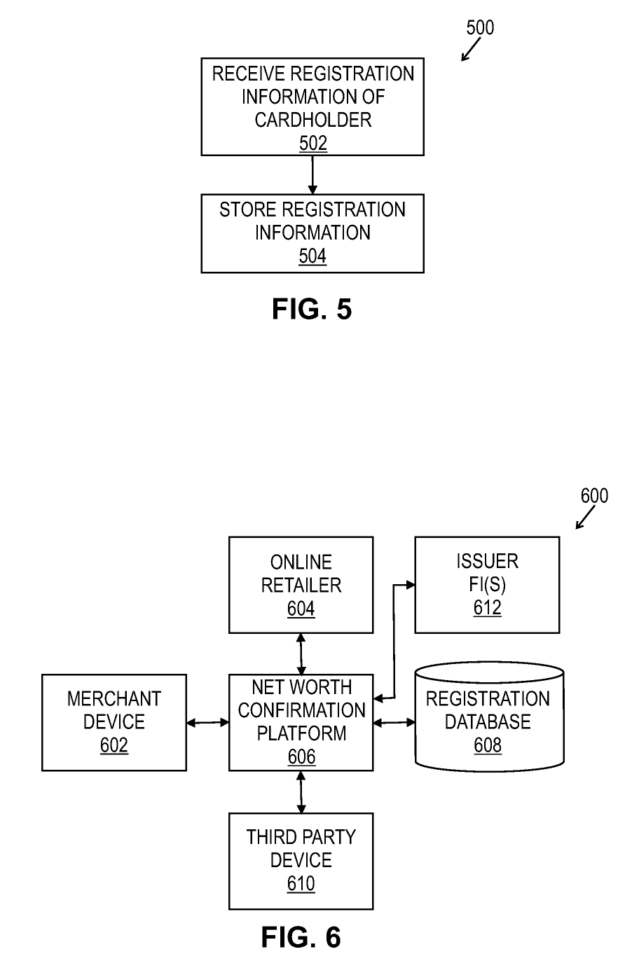

FIG. 6 is a block diagram overview of an alternate net worth confirmation platform system 600 according to some embodiments. A merchant device 602 or online retailer 604 transmits purchase transaction information directly to a net worth confirmation platform 606, such as by using an Application Programming Interface (“API”). The net worth confirmation platform 606 may access a registration database 608 to identify the customer (who has pre-registered for the net worth confirmation service) and to exchange information with a third party device 610, such as a service that tracks and verifies different types of financial assets that are owned by the customer (for example, stocks, bonds, real estate, and the like). The net worth confirmation platform 606 may also be operably connected to one or more Issuer financial institutions (FIs) 612 that may also transmit information to, and receive information from, the net worth confirmation platform via an API. In some implementations, the net worth confirmation platform 606 transmits the appropriate results (an estimate of the customer's net worth) to the merchant device 602 or to the online retailer 604 (for example, via the customer's online shopping cart). In some embodiments, the merchant can utilize the received customer's estimated net worth information to determine whether or not to extend credit to the customer regarding a purchase transaction. Moreover, in some implementations the net worth confirmation platform 606 transmits an estimate of the cardholder's net worth to one or more Issuer FIs 612 that may be utilized, for example, by an Issuer FI to determine if any particular cardholder's should receive upgrade offers and/or other financial services offers, and the like.

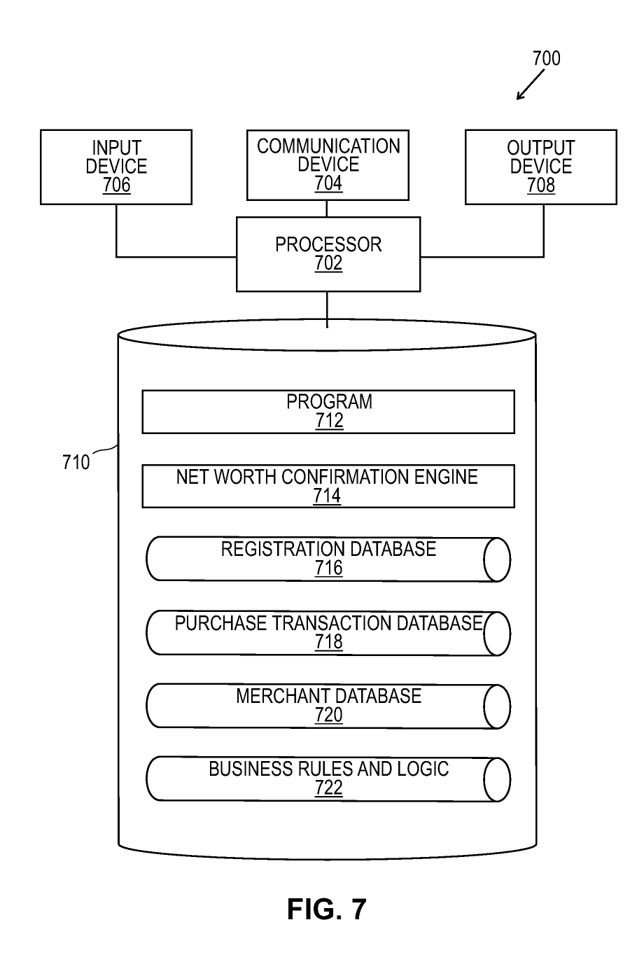

Note that the embodiments described herein may be implemented using any number of different hardware configurations. For example, FIG. 7 illustrates an embodiment of a net worth confirmation platform 700 that may be, for example, associated with the systems 100, 200, or 600 of FIGS. 1, 2, and 6. The asset confirmation platform 700 comprises a processor 702, such as one or more commercially available Central Processing Units (CPUs) in the form of one-chip microprocessors, coupled to a communication device 704 configured to communicate via a communication network (not shown in FIG. 7). The communication device 704 may be configured for communications with, for example, one or more transaction databases. The net worth confirmation platform 700 further includes an input device 706 (for example, a computer mouse and/or keyboard which may be utilized to enter information about business rules or logic) and an output device 708 (such as a computer monitor (which may be a touch screen) or printer to, for example, output reports and/or support user interfaces).

The processor 702 also communicates with a storage device 710. The storage device 710 may comprise any appropriate information storage device, including combinations of magnetic storage devices (e.g., a hard disk drive), optical storage devices, and/or semiconductor memory devices. The storage device 710 may therefore be any type of non-transitory computer readable medium and/or any form of computer readable media capable of storing computer instructions and/or application programs and/or data. It should be understood that non-transitory computer-readable media comprise all computer-readable media, with the sole exception being a transitory, propagating signal. In some embodiments, the storage device 710 stores a computer program 712 and/or net worth confirmation platform logic 714 for controlling the processor 702. The processor 702 performs instructions of the programs 712, 714, and thereby operates in accordance with any of the embodiments described herein. For example, the processor 702 may receive transaction information about a purchase being made by a customer from a merchant. Responsive to the received transaction information, the processor 702 may automatically determine that a customer has registered for the net worth estimate service and then provide a monetary value of at least one asset owned by the customer. The asset might be associated with, for example, stocks owned by the customer in a trading account. The processor may then operate to authorize the purchase transaction on behalf of the Issuer financial institution that issued the customer's payment card account according to the methods disclosed herein.

The programs 712, 714 may be stored in a compressed, uncompiled and/or encrypted format. The programs 712, 714 may furthermore include other program elements, such as an operating system, a database management system, and/or device drivers used by the processor 702 to interface with peripheral devices.

As used herein, information may be “received” by or “transmitted” to, for example, the net worth confirmation platform 700 from another device, or a software application or module within the asset confirmation platform 700 from another software application, module, or any other source.

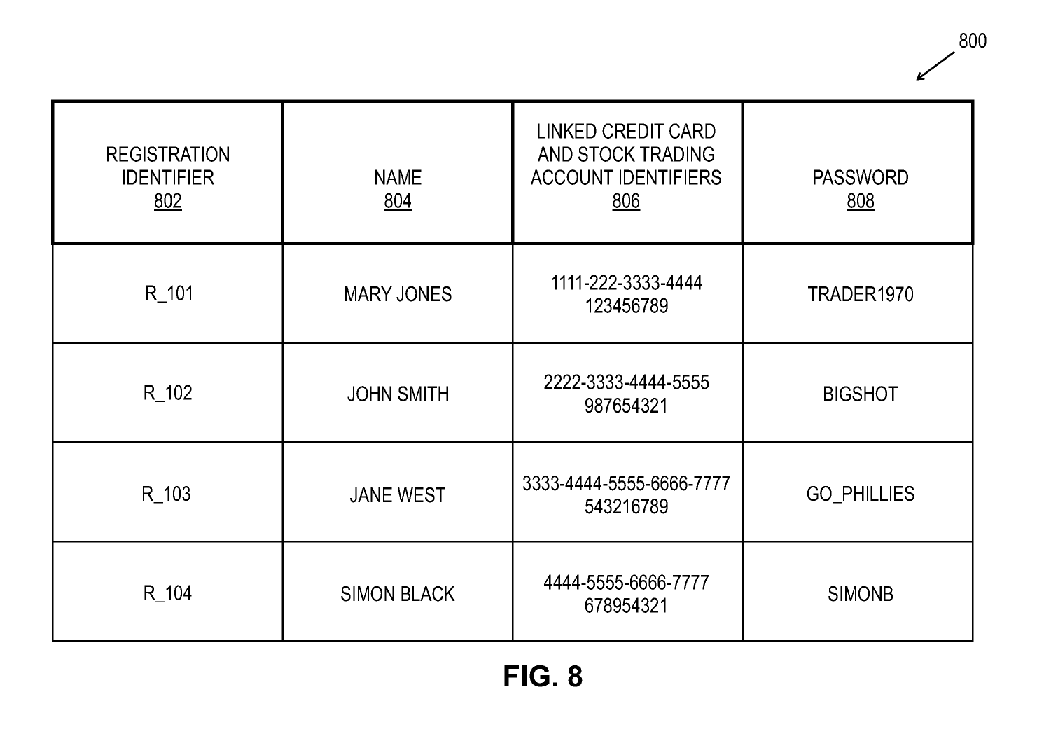

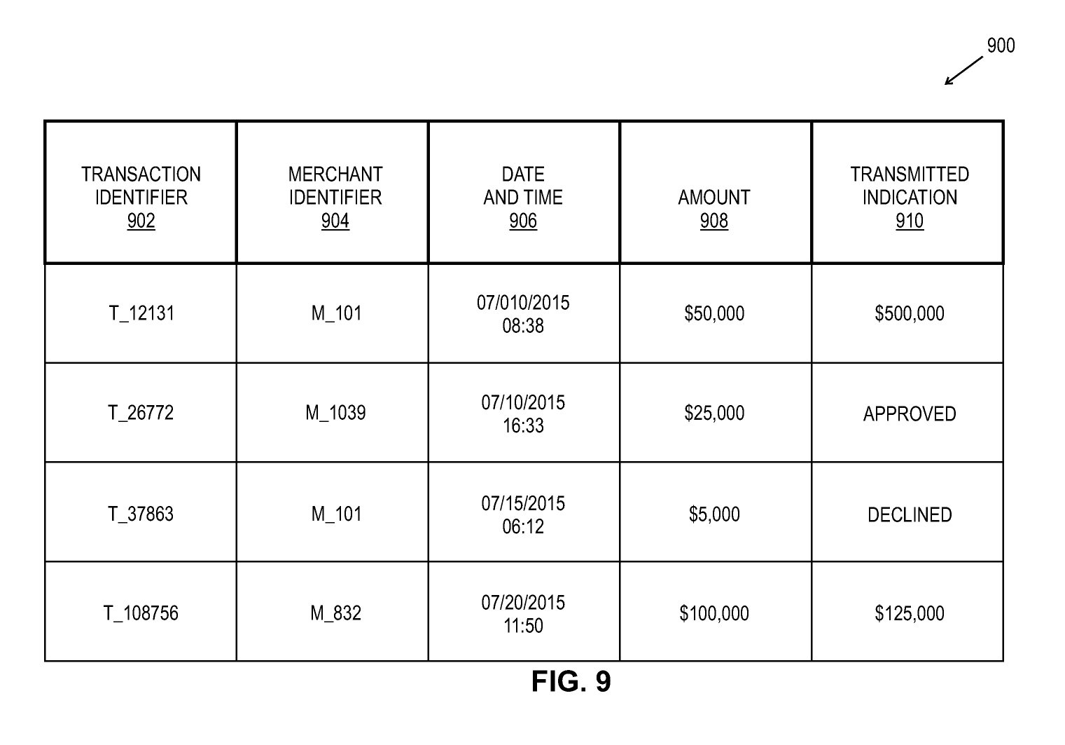

Referring again to FIG. 7, in some embodiments the storage device 710 further stores a registration database 716, a purchase transaction database 718, a merchant database 720, and business rules and logic 722. Some examples of databases that may be used in connection with the net worth confirmation platform 700 will now be described in detail with respect to FIGS. 8 and 9. Note that the databases described herein are only examples, and additional and/or different information may actually be stored therein. Moreover, various databases might be split or combined in accordance with any of the embodiments described herein. For example, the merchant database 720 and business rules and logic 722 might be combined and/or linked to each other within the net worth confirmation platform 700.

Note that the merchant database 720 may store a “business classification,” which is a group of merchants and/or businesses, by the type of goods and/or service the merchant and/or business provides. For example, the group of merchants and/or businesses can include merchants and/or business, which provide similar goods and/or services. In addition, the merchants and/or businesses can be classified based on geographical location, sales, and any other type of classification, which can be used to associate a merchant and/or business with similar goods, services, locations, economic and/or business sector, industry and/or industry group.

Similarly, the merchant database 720 might store a Merchant Category Code (“MCC”) which is a four-digit number created by MasterCard® or VISA® and assigned to a business by the acquirer financial institution when the business first starts accepting one of these cards as a form of payment. The MCC is used to classify the business by the type of goods or services it provides. For example, in the United States, the merchant category code can be used to determine if a payment needs to be reported to the IRS for tax purposes. In addition, Merchant Category Codes (or “MCCs”) are used by card Issuer financial institutions to categorize, track or restrict certain types of purchases. In some implementations, the business classification and/or MCC might be used to apply different business rules and logic 722 to transactions. For example, a purchase transaction that was approved from an automobile dealership might not have been approved if it had been received from a casino.

FIG. 8 is a table 800 illustrating the types of data that may be stored in a registration database according to some embodiments. For example, the registration database 716 of FIG. 7 may include such data, which may be stored at the net worth confirmation platform 700. In particular, the table 800 may include entries identifying customers who have registered or enrolled or signed-up to use the net worth confirmation service. The table may also define columns or fields 802, 804, 806 and 808 for each of the entries. In the embodiment of FIG. 8, the fields for each consumer include a registration identifier 802, a customer's name 804, linked credit card and stock trading account identifiers 806, and a stock trading account password 808. The registration database 800 may be updated, for example, as customers sign-up to the use the net worth confirmation service (for example, by activating that feature for their credit card accounts).

The registration identifier 802 may be, for example, a unique alphanumeric code identifying an asset confirmation customer associated with the name 804. The linked credit card and stock trading account identifiers 806 may, for example, link the customer's credit card account number with his or her stock trading account number. The customer's password 808 may, for example, permit the net worth confirmation platform to “log into” the customer's stock trading account to determine or to obtain a snapshot of the current value of his or her stock holdings.

FIG. 9 is a table 900 illustrating the types of data that may be stored in a purchase transaction database according to some embodiments. For example, the purchase transaction database 718 of FIG. 7 may include such data, which may be stored at the net worth confirmation platform 700. In particular, the table 900 may include entries identifying transactions that have been processed via a particular payment card account (for example, a cardholder's premium credit card account transactions). The table may also define fields for each entry, including a transaction identifier 902, a merchant identifier 904, a date and time 906, a transaction amount 908, and a transmitted indication 910. The transaction database 900 may be created and updated, for example, as merchant devices, credit card network requests, and/or online electronic wallets are used to provide purchase transaction information.

The purchase transaction identifier 902 may be associated with a particular transaction (for example, a purchase at an auction house). According to some embodiments, an account identifier may also be stored, such as a unique alphanumeric code identifying a payment account or a Primary Account Number (“PAN”). The merchant identifier 904 may indicate which merchant submitted the purchase transaction information. The date and time 906 may indicate when the transaction occurred, and the amount 908 may indicate the total monetary amount of the transaction. The transmitted indication 910 might include information such as the estimated net worth value of the customer's assets at that time and date, a transaction approval or denial, and the like.

Embodiments disclosed herein may enlarge the scope of the customer's purchase power by not limiting it to his or her cash on hand (in savings and checking accounts) and the credit available on his or her credit card. Instead, the estimated net worth of the customer may be quickly and easily determined (based on assets such as stocks, bonds and/or real estate) and then applied to a particular purchase transaction to determine whether that purchase transaction can be authorized when the customer has exceeded the credit limit (or available credit) of his or her payment card account. By registering for the net worth confirmation service and providing information regarding multiple financial accounts and/or other valuable assets, a customer may therefore expand his or her credit worthiness profile so as to permit purchase transactions which otherwise would have been declined.

As used herein and in the appended claims, the term “payment card account” includes a credit card account or a deposit account or other type of financial account that the account holder may access using a debit card. The term “payment card account number” includes a number that identifies a payment card system account or a number carried by a payment card, or a number that is used to route a transaction in a payment system that handles debit card and/or credit card transactions. The term “payment card” may include, but is not limited to, a credit card, a debit card, a transit card, an identification card, a loyalty card, and/or a gift card.

As used herein and in the appended claims, the terms “payment card system” and/or “payment network” refers to a system and/or network for handling purchase transactions and related transactions, which may be operated by a payment card system operator such as MasterCard International Incorporated, or a similar system. In some embodiments, the term “payment card system” may be limited to systems in which member financial institutions (such as banks) issue payment card accounts to individuals, businesses and/or other organizations.

Although the present disclosure describes specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method, comprising:
receiving, at a net worth confirmation platform, transaction information comprising payment account information and a transaction amount concerning a purchase transaction of a customer;
transmitting the transaction information to an Issuer financial institution (FI);
receiving, by the net worth confirmation platform, an indication from the Issuer FI that the that the transaction is unauthorized;
determining, by the net worth confirmation platform, that at least one business rule applies to the transaction, and an overage amount based on an available credit amount of the customer's payment account and the transaction amount;
determining, by the net worth confirmation platform, a net worth estimate of the customer based on at least one asset of the customer; and
transmitting, by the net worth confirmation platform, a transaction authorization message to the merchant for the purchase transaction when the at least one business rule is satisfied based on the net worth estimate of the customer.

2. The method of claim 1, wherein the customer's payment account comprises one of a credit card account, a debit card account, a bank account, a pre-paid card account, a loyalty card account, or a stored value card account.

3. The method of claim 1, wherein the at least one asset comprises the value of at least one of a stock trading account, a money market accounts, a real estate investment trust account, a retirement fund account, and a college saving plan account.

4. The method of claim 1, wherein the at least one asset comprises the value of at least one of a primary residence, real estate holding(s), a boat, and an automobile.

5. The method of claim 1, wherein determining the customer's net worth estimate comprises exchanging information with a financial trading account platform associated with the customer.

6. The method of claim 1, wherein determining the customer's net worth estimate further comprises subtracting the value of liabilities of the customer.

7. The method of claim 1, further comprising, prior to receiving transaction information:
receiving opt-in registration information associated with the customer, the registration information including at least one of a name, a payment account identifier, a trading account identifier, and a password; and
storing the opt-in registration information.

8. The method of claim 1, wherein the transaction information is associated with at least one of a payment card network or an online purchase.

9. The method of claim 1, wherein the transaction information is received directly from a merchant device.

10. A non-transitory computer-readable medium storing instructions configured to cause a processor to:
receive transaction information comprising payment account information and a transaction amount concerning a purchase transaction of a customer;
transmit the transaction information to an Issuer financial institution (FI);
receive an indication from the Issuer FI that the that the transaction is declined due to insufficient funding;
determine that at least one business rule applies to the transaction, and an overage amount based on an available credit amount of a payment account of the customer and the transaction amount;
determine a net worth estimate of the customer based on at least one asset of the customer; and
transmit a transaction authorization message to override the indication of the declined transaction to the merchant for the purchase transaction when the at least one business rule is satisfied based on the customer's net worth estimate.

11. The non-transitory computer-readable medium of claim 10, wherein the at least one asset includes stocks owned by the customer and said determining includes exchanging information with a trading account platform associated with the customer.

12. The non-transitory computer-readable medium of claim 10, further comprising, prior to the instructions for receiving the transaction information, instructions configured to cause the processor to:
receive opt-in registration information associated with the customer, the registration information including a trading account identifier and a password; and
store the registration information.

13. The non-transitory computer-readable medium of claim 10, wherein the transaction information is associated with at least one of a payment card network, an online purchase, an electronic shopping cart associated with the merchant, and an electronic wallet account.

14. The non-transitory computer-readable medium of claim 10, wherein the transaction information is received directly from one of a merchant device, and a web page.

15. A system, comprising:
a payment network; and
a net worth aggregator platform operably connected to the payment network,
wherein the payment network receives purchase transaction information and transmits the transaction information to the net worth aggregator platform; and
wherein the net worth aggregator platform automatically determines a monetary value of at least one asset owned by the customer based on the transaction information, and transmits a monetary value of the at least one asset to a merchant.

16. The system of claim 15, wherein the at least one asset comprises stocks owned by the customer and the net worth aggregator platform exchanges information with a trading account platform associated with the customer.

17. The system of claim 15, wherein the net worth aggregator computer is configured to receive customer opt-in registration information, the customer opt-in registration information including a trading account identifier and a password, and store the received opt-in registration information.

18. The system of claim 15, wherein the transaction information is associated with at least one of a payment card network, an online purchase, an electronic shopping cart associated with the merchant, and an electronic wallet account.
